(19) United States
(12) Patent Application Publication
(10) Pub. No.: US 2009/0319674 A1
(43) Pub. Date: Dec. 24, 2009

(54) TECHNIQUES TO MANAGE COMMUNICATIONS BETWEEN RELAY SERVERS

(75) Inventors: Wajih Yahyaoui, Redmond, WA (US); Tim Moore, Redmond, WA (US); Tony Bell, Redmond, WA (US); Neil Deason, Seattle, WA (US); Xianjie Zhang, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/144,672

(22) Filed: Jun. 24, 2008

(51) Int. Cl. G06F 15/16

(52) U.S. Cl. 709/228

(57) ABSTRACT

Techniques to manage communications between relay servers are described. A system may include multiple relay servers each having an enhanced relay control module. The enhanced relay control module may be operative to manage communications between private clients communicating over the first relay server and the second relay server. The enhanced relay control module may establish a media channel between control ports for the first and second relay servers when a port range attribute for at least one of the first or second relay servers is turned off. Other embodiments are described and claimed.

### BACKGROUND

Network Address Translation (NAT) refers to a technique that involves re-writing the source and/or destination addresses of network packets as they pass through a router or firewall. A NAT device, such as a NAT-enabled router, allows multiple hosts on a private network to access a public network such as the Internet using a single public network address, such as an Internet Protocol (IP) address. A NAT device, however, sometimes makes it difficult to provide connectivity between a device on a private network and a device on a public network or another private network.

To compensate for end-to-end connectivity problems, certain protocols have been developed to allow a public client to traverse a NAT device. One such protocol is the Session Traversal Utilities for NAT (STUN) protocol. The STUN protocol allows a public client to obtain a transport address which may be useful for receiving packets from a peer. Addresses obtained by STUN, however, may not be usable by all peers. The STUN addresses may not work depending on the topological conditions of the network. To augment or enhance the STUN protocol, a public-accessible relay server may be implemented to relay packets of media information between any peers that can send packets to the public Internet, including public peers and private peers. The Traversal Using Relay NAT (TURN) protocol is one protocol designed to allow a client to obtain IP addresses and ports from such a relay server. When communicating between multiple relay servers, however, the TURN protocol requires opening a range of ports on the public-side of the relay servers. This may pose an elevated security risk. Accordingly, there may be a need for improved techniques for private clients to communicate media information through multiple relay servers, thereby improving connectivity across multiple networks implementing various NAT devices.

### SUMMARY

Various embodiments may be generally directed to techniques to manage communications between relay servers. Some embodiments may be particularly directed to techniques for establishing a media channel between private clients through multiple relay servers in a heterogeneous communications system comprising both public networks and private networks. In one embodiment, the relay servers may be implemented as a STUN server and/or a TURN server to allow NAT traversal by various public and private clients.

In one embodiment, for example, a communications system may include, among other elements, multiple relay servers each having an enhanced relay control module. The enhanced relay control module may be operative to manage communications between private clients communicating over the first relay server and the second relay server. The enhanced relay control module may establish a media channel between control ports for the first and second relay servers when a port range attribute for at least one of the first or second relay servers is turned off. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates one embodiment of a communication system.

FIG. 2 illustrates one embodiment of a logic flow.

FIG. 3A illustrates one embodiment of a first message flow.

FIG. 3B illustrates one embodiment of a second message flow.

FIG. 4 illustrates one embodiment of a channel framed message.

FIG. 5 illustrates one embodiment of a computing system architecture.

FIG. 6 illustrates one embodiment of an article of manufacture.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Relay servers are used by clients that do not have direct access to a public network, such as the Internet, to acquire a public transport address. The allocated transport address is used to receive data from a selected peer. A typical communications system architecture may include a relay server placed in a perimeter network for an entity, such as a corporation or business. The relay server may include two network interfaces, such as a public network interface on its public edge used to communicate with a public network, and a private network interface on its private edge to communicate with a private network. A firewall is typically deployed on both the public and private edges of the perimeter network.

Some relay servers require the relay server to open a bi-directional range of ports on both the relay server and the public firewall. The port range may include ports allocated for different network transports, such as a network transport using the User Datagram Protocol (UDP) or the Transmission Control Protocol (TCP), among others. This increases the potential connectivity scenarios between private clients on different private networks.

Some entities are not comfortable, however, opening a relatively large incoming port range on the public firewall. For example, this may elevate security risks for the private network. To reduce such security risks, an entity may limit port allocations to opening control ports on the public firewall for incoming connections, such as UDP control port 3478, TCP control port 443, and others. While this is a supported scenario in a limited sense by allowing private clients to have limited connectivity through the relay server, it reduces or completely breaks connectivity for federated clients and other devices using different relay services. For example, in some cases there is no provision for data to flow between the allocated ports of two relay servers separated by a firewall that does not have an open port range.

To solve these and other problems, various embodiments may be generally directed to an enhanced relay server protocol or protocol extension designed to enable communication between multiple relay servers separated by a firewall that does not have an open inbound port range. Some embodiments may be particularly directed to an enhanced relay server protocol or protocol extension designed for specific use with relay servers implementing the TURN and/or STUN protocols to allow NAT traversal by various public and private clients.

In one embodiment, for example, multiple relay servers may each implement an enhanced relay control module. The enhanced relay control module may implement an enhanced relay server protocol, for example, as an extension of the TURN protocol, among other protocols. The enhanced relay control module may be operative to manage communications between private clients communicating over the first relay server and the second relay server through a firewall or other filtering or blocking mechanism. The enhanced relay control module may establish a media channel between control ports for the first and second relay servers when a port range attribute for at least one of the first or second relay servers is turned off. The control ports may comprise control ports for different network transport protocols, such as the TURN UDP and/or TCP control ports as designated by the TURN suite of protocols, among other uniquely designated ports. Consequently, the enhanced relay control module provides for an alternate path to establish a media channel to communicate media information between two private clients on separate private networks utilizing at least two relay servers across a firewall or other security technique. In this manner, the private clients may experience enhanced connectivity, which may be particularly desirable for federated clients, such as typically found in a business environment.

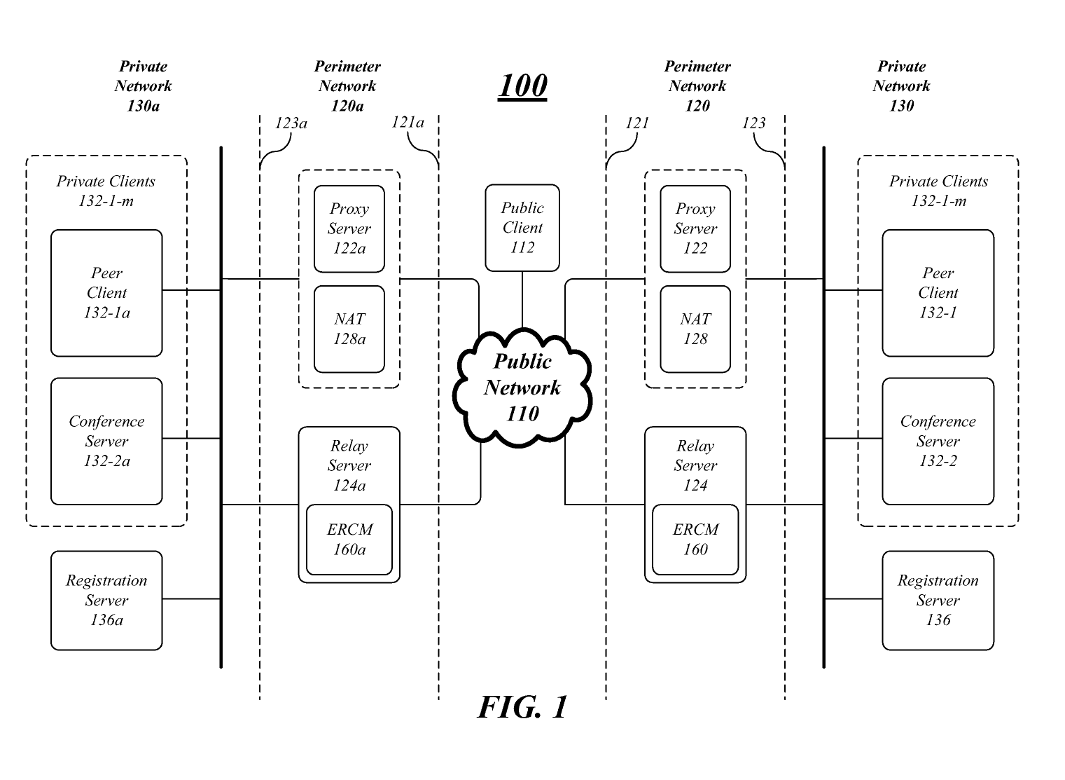

FIG. 1 illustrates one embodiment of a communications system 100. The communications system 100 may represent a general system architecture suitable for implementing various embodiments. The communications system 100 may comprise multiple elements. An element may comprise any physical or logical structure arranged to perform certain operations. Each element may be implemented as a hardware element, a software element, or any combination thereof, as desired for a given set of design parameters or performance constraints. Examples of hardware elements may include without limitation devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include without limitation any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although the communications system 100 as shown in FIG. 1 has a limited number of elements in a certain topology, it may be appreciated that the communications system 100 may include more or less elements in alternate topologies as desired for a given implementation. The embodiments are not limited in this context.

In the following detailed description, some elements are labeled with a base number to uniquely identify the element. In some cases, a same or similar element implemented by a different device or network may have the same base number followed by the letter designation “a” to form a corresponding number. For example, the communications system 100 may include a relay server 124 and a relay server 124a. It may be appreciated that the description provided for an element identified by a base number is applicable to the same or similar element identified by the corresponding number. For example, the relay server 124 may be implemented with the same or similar structures and operations as the relay server 124a. In some cases, descriptions are limited to one element for purposes of clarity and conciseness, and not necessarily by limitation.

As used herein the terms “system,” “subsystem,” “component,” and “module” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

As shown in the illustrated embodiment of FIG. 1, the communications system 100 comprises a public network 110, a perimeter network 120, and a private network 130. The public network 110 may comprise any network accessible to a general class of users without discrimination. An example of the public network 110 may include the Internet. The private network 130 may comprise any network accessible to a limited class of users with discrimination between users and controlled access. An example of the private network 130 may include a network for a business entity, such as an enterprise network. A perimeter network 120 may comprise any network accessible by both a general class of users and a limited class of users using respective public and private interfaces, thereby providing some measure of interoperability between the networks 110, 130.

In various embodiments, the networks 110, 120 and 130 may each comprise packet-switched networks capable of supporting multimedia communications between various network devices, such as a Voice Over Internet Protocol (VoIP) or Voice Over Packet (VOP) (collectively referred to herein as “VoIP”) communication session. For example, the various elements of the networks 110, 120 and 130 may be capable of establishing a VoIP peer-to-peer telephone call or multi-party conference call using various types of VoIP technologies. In one embodiment, for example, the VoIP technologies may include a VoIP signaling protocol as defined and promulgated by the Internet Engineering Task Force (IETF) standards organization, such as the Session Initiation Protocol (SIP) as defined by the IETF series RFC 3261, 3265, 3853, 4320 and progeny, revisions and variants. In general, the SIP signaling protocol is an application-layer control and/or signaling protocol for creating, modifying, and terminating sessions with one or more participants. These sessions include IP telephone calls, multimedia distribution, and multimedia conferences. In one embodiment, for example, the VoIP technologies may include a data or media format protocol, such as the Real-time Transport Protocol (RTP) and Real-time Transport Control Protocol (RTCP) as defined by the IETF RFC 3550 and progeny, revisions and variants. The RTP/RTCP standard defines a uniform or standardized packet format for delivering multimedia information (e.g., audio and video) over a packet-switched network, such as the packet-switched networks 110, 120 and 130. Although some embodiments may utilize the SIP and RTP/RTCP protocols by way of example and not limitation, it may be appreciated that other VoIP protocols may also be used as desired for a given implementation.

In various embodiments, the various elements of the networks 110, 120 and 130 may perform various types of multimedia communications between various elements of the networks 110, 120 and 130. The multimedia communications may include communicating different types of information over a packet-switched network in the form of discrete data sets, such as packets, frames, packet data units (PDU), cells, segments or other delimited groups of information. The different types of information may include control information and media information. Control information may refer to any data representing commands, instructions or control words meant for an automated system. For example, control information may be used to route media information through a system, or instruct a node to process the media information in a predetermined manner. Media information may refer to any data representing content meant for a user. Examples of content may include, for example, data from a voice conversation, videoconference, streaming video, electronic mail (“email”) message, voice mail message, alphanumeric symbols, graphics, pictures, images, video, audio, text and so forth. Data from a voice conversation may be, for example, speech information, silence periods, background noise, comfort noise, tones and so forth. Although the networks 110, 120 and 130 are primarily implemented as packet-switched networks, in some cases one or more of these networks may have suitable interfaces and equipment to support various circuit-switched networks, such as the Public Switched Telephone Network (PSTN), for example.

In various embodiments, the public network 110 may include one or more public clients 112. The public client 112 may be implemented as a part, component or sub-system of an electronic device having a public network address. Examples for electronic devices suitable for use as the public client 112 may include, without limitation, a processing system, computer, server, work station, appliance, terminal, personal computer, laptop, ultra-laptop, handheld computer, personal digital assistant, television, digital television, set top box, telephone, mobile telephone, cellular telephone, handset, wireless access point, base station, subscriber station, mobile subscriber center, radio network controller, conference system, router, hub, gateway, bridge, switch, machine, or combination thereof.

In various embodiments, the private network 130 may include one or more private clients 132-1-m. The private clients 132-1-m may be implemented as a part, component or sub-system of an electronic device having a private network address, which is a network address generally known to the private network 130 but not publicly routable. Examples for electronic devices suitable for use as the private clients 132-1-m may include the same or similar electronic devices provided with reference to the public client 112. As shown in the illustrated embodiment of FIG. 1, for example, the private clients 132-1-m may include a peer client 132-1 and a conference server 132-2. The peer client 132-1 may comprise a peer device to the public client 112, or another peer client 132-1a, both of which may be used as a multimedia end point to terminate a VoIP telephone call. For example, the peer clients 132-1, 132-1a may comprise packet-switched telephones, such as a VoIP phone or SIP phone. The conference server 132-2 may comprise a multimedia conferencing server to support multiple VoIP telephone calls for a multimedia conference session between multiple multimedia end points, such as two or more public clients and/or private clients. The conference server 132-2 may include, or be communicatively coupled to, various conference system components suitable for establishing, managing and terminating VoIP conference calls, such as a conference focus, one or more audio video multipoint control units (AVMCUs), gateways, bridges and so forth.

In various embodiments, the private network 130 may include a registration server 136. The registration server 136 is a centralized entity that is responsible for various network management operations for the private network 130, such as authenticating users, routing requests inside the private network 130, maintaining the Active Directory for a server operating system, and so forth. For example, before routing, the registration server 136 validates all requests that through it and ensures that the Uniform Resource Identifier (URI) in the FROM field of the SIP header of any registration requests matches the identity of the requestor. In one embodiment, for example, the registration server 136 may be implemented using a MICROSOFT® OFFICE COMMUNICATIONS SERVER, made by Microsoft Corporation, Redmond, Wash. In this implementation, the peer clients 132-1, 132-1a may be implemented as MICROSOFT OFFICE COMMUNICATOR CLIENTS, also made by Microsoft Corporation, Redmond, Wash. The embodiments, however, are not limited to these examples.

In various embodiments, the perimeter network 120 may include various network devices to facilitate interoperability operations between devices within the networks 110, 130, such as the peer clients 132-1, 132-1a. In some embodiments, the perimeter network 120 may comprise network devices having public network interfaces accessible from the public client 112 from the public network 110, and private network interfaces accessible from the private clients 132-1-m.

In various embodiments, the perimeter network 120 may optionally include a proxy server 122. The proxy server 122 may generally control access to the private network 130. The proxy server 122 is a server that accepts client requests from the public Internet and routes it to the appropriate destination based on the client request. It also validates a client request before forwarding. For example, the proxy server 122 may operate as a connection point for external or public clients for various VoIP operations, such as SIP signaling. In one embodiment, for example, the proxy server 122 provides an authenticated and secure SIP channel to discover the location of, and obtain authentication credentials for, a STUN relay service provided by the relay server 124 in multimedia communications systems, such as the communications system 100. The SIP clients or User Agents (UA) may be on a public network or a private network, such as respective networks 110, 130. The authentication credentials may be obtained either in a first party manner by a given client for use by itself, or alternatively, in a third party manner where a given client obtains authentication credentials on behalf of another client, such as for adding a client to a conference call system. In the latter case the third party should be authenticated and authorized to obtain this information on behalf of others. The proxy server 122 ensures that communications on the channel used to obtain the authentication credentials are secure and external or public clients are authenticated.

In various embodiments, the perimeter network 120 may include one or more network devices to implement NAT and/or firewall operations. Such operations are typically performed by devices disposed between the public network 110 and the private network 130. In some cases, these operations are typically performed by devices disposed between the public network 110 and the proxy server 122, as indicated by the dashed lines 121, 121a. In the illustrated embodiment shown in FIG. 1, for example, the perimeter network 120 includes the NAT 128. Although the topology of the illustrated embodiment in FIG. 1 shows the NAT 128 parallel to the proxy server 122, it may be appreciated that the NAT 128 may be positioned between the proxy server 122 and the public network 110 as indicated by the dashed lines 121, 121a. The embodiments are not limited in this context.

The NAT 128 may implement various NAT operations for the private network 130. The NAT 128 may re-write the source and/or destination addresses of network packets as they pass between the networks 110, 130. In this manner, the NAT 128 allows multiple hosts (e.g., the private clients 132-1-m) on the private network to access the public network 110 using a single public network address, such as an IP address. The NAT 128, however, sometimes makes it difficult to provide connectivity between the public client 112 and the private clients 132-1-m for a number of reasons, such as security issues since the public client 112 is unknown to the private network 130, difficulty in obtaining a network address for a client behind a NAT device, overhead costs, and so forth. Similarly, the private network 130 may be protected by a corporate firewall that prevents outside users from gaining access to the resources of the private network 130. The corporate firewall may also make it difficult to provide connectivity between public and private clients.

To compensate for end-to-end connectivity problems, the perimeter networks 120, 120a may implement respective relay servers 124, 124a to allow the public client 112 and/or private clients 132-1-m to traverse a corporate firewall and/or the NATs 128, 128a. The relay server 124 may be any electronic device as previously described with respect to the clients 112, 132 arranged to communicate any data such as media information between various media end points or destinations (e.g., public or private clients). In one embodiment, for example, the relay server 124 may be arranged to operate in accordance with the Internet Engineering Task Force (IETF) Session Utilities for NAT (STUN) protocol, as defined by the IETF RFC 3489 and its progeny, revisions and variants. When implementing the STUN protocol, the relay server 124 may sometimes be referred to as a STUN server. The STUN protocol provides a suite of tools for facilitating the traversal of the NAT device 128. Specifically, it defines the Binding Request, which is used by a client to determine its reflexive transport address towards the STUN server. The reflexive transport address can be used by the client for receiving packets from peers, but only when the client is behind a certain type of NAT. In particular, if a client is behind a type of NAT whose mapping behavior is address or address and port dependent, then the reflexive transport address will not be usable for communicating with a peer. In this case, the only way to obtain a transport address that can be used for corresponding with a peer through such a NAT is to make use of a relay, such as a relay server 124. The relay server 124 sits on the public side of the NAT device 128, and allocates transport addresses to clients reaching it from behind the private side of the NAT device 128 (e.g., network 130). These allocated addresses are from interfaces on the relay server 124. When the relay server 124 receives a packet on one of these allocated addresses, the relay server 124 forwards it toward the client.

In addition to the STUN protocol, the relay server 124 may be arranged to implement an extension of the STUN protocol referred to as the IETF Traversal Using Relays around NAT (TURN), as defined by the IETF Internet Draft titled “Traversal Using Relays around NAT (TURN): Relay Extensions to Session Traversal Utilities for NAT (STUN)”, Jul. 8, 2007, and its progeny, revisions and variants. The TURN protocol allows a client to request an address on the STUN server itself, so that the STUN server acts as a relay. To accomplish that, this extension defines a handful of new STUN requests and indications. The ALLOCATE REQUEST is a fundamental component of this set of extensions. It is used to provide the client with a transport address that is relayed through the STUN server. A transport address which relays through an intermediary is called a relayed transport address. A STUN server that supports these extensions is sometimes referred to as a “STUN relay” or more simply a “relay,” a “TURN server,” a “TURN relay server,” or similar designations. When the relay server 124 is configured for operation as a TURN server, the public client 112 and the private clients 132-1-m may be arranged to operate as clients, in accordance with the TURN protocol. The clients can communicate with a TURN server using any number of suitable communications transports, such as the (UDP), Transmission Control Protocol (TCP), or Transport Layer Security (TLS) over TCP. In some cases, a TURN server can even relay traffic between two different transports with certain restrictions.

To operate using the TURN protocol, the relay server 124 needs to authenticate the clients 112, 132 prior to allowing the clients 112, 132 to begin communicating media information through the relay server 124. The relay server 124 performs authentication operations for the clients 112, 132 using a shared secret between the relay server 124 and the respective clients 112, 132. The relay server 124 typically generates the shared secret, and distributes the shared secret to the clients 112, 132. Authentication operations may be performed using the registration server 136.

In general operation, the relay servers 124, 124a may implement the STUN and/or TURN protocols, which in some cases require the relay servers 124, 124a to open a bi-directional range of ports on both the relay servers 124, 124a and the public firewalls to allow private clients from different networks to communicate using the relay servers 124, 124a. The port range may include ports allocated for different network transports, such as a network transport using UDP and/or TCP, among others. This increases the potential connectivity scenarios between the public clients 112 and/or the private clients 132-1-m. Some entities are not comfortable, however, opening a relatively large incoming port range on the public firewall. For example, this may elevate security risks for the private network.

To solve these and other problems, the relay servers 124, 124a may implement respective enhanced relay control modules 160, 160a. The enhanced relay control modules 160, 160a may implement an enhanced relay server protocol or protocol extension designed to enable communication between the relay servers 124, 124a separated by one or more firewalls that does not have an open inbound port range. In particular, the enhanced relay control modules 160, 160a may implement an enhanced relay server protocol or protocol extension designed for specific use with the relay servers 124, 124a implementing the TURN and/or STUN protocols to allow NAT traversal by various public and private clients. In one embodiment, for example, the enhanced relay control modules 160, 160a may establish a media channel between control ports for the respective relay servers 124, 124a when a port range attribute for one or both of the relay servers 124, 124a is turned off.

In various embodiments, the peer client 132-1 may comprise a TURN client on the private network 130 configured to utilize the TURN protocol to allocate a public transport address from a relay server, such as the relay server 124. The transport address can then be used to communicate with a selected peer that also has a public transport address. If the peer is on a private network, such as the peer client 132-l a on the private network 130a, it too will need to allocate a public transport address from a TURN server, such as the relay server 124a. If both peer clients 132-1, 132-1a allocate from the same relay server, then data flow between the two takes place over a TURN control port, such as UDP 3478 or TCP 443. If the peer clients 132-1, 132-1-a allocate from different relay servers, data flow typically occurs between the two allocated ports. This forces the administrator of the perimeter network 120 to open a range of ports on the public edge firewall.

The enhanced relay server protocol is designed to allow data flow between two relay servers 124, 124a in different perimeter networks 120, 120a without the need to open a relatively large incoming port range on the public edge firewalls. The enhanced relay server protocol allows for the use of UDP as a transport between the relay servers 124, 124a for all media sessions (e.g., audio/video sessions) regardless of the transport used between the clients and their respective relay servers. TCP can be used as a transport for all client TCP sessions that require reliable data delivery as identified in the optional Service Quality attribute used by the client in its ALLOCATE REQUEST message. If the ALLOCATE REQUEST message does not contain the SERVICE QUALITY attribute, the relay server can assume best-effort delivery and use UDP as a transport between the relay servers 124, 124a.

The clients 132-1-m allocates a public transport address from its respective relay server 124, 124a. The clients exchange the allocated transport address in the Session Description Protocol (SDP) portion of a SIP dialog. Once a client knows the transport address of a peer it can use a TURN SEND REQUEST message to send data to that peer.

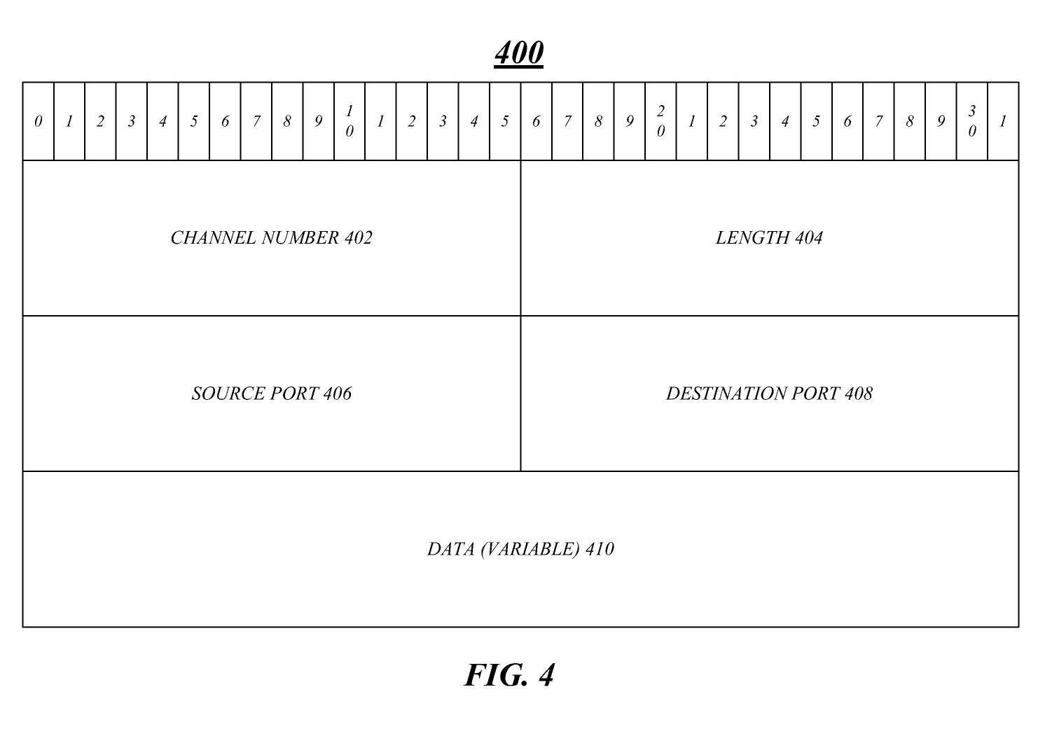

When the relay server 124 (or 124a) receives a SEND REQUEST message it sets permissions and sends the data directly from the client's allocated transport address to the destination address identified in the DESTINATION ADDRESS attribute of the SEND REQUEST message. In parallel the relay server 124 also sends a special type of innovative message referred to as a “channel framed message” from the TURN port. The channel framed message is sent over UDP to the same destination address but uses the destination port of 3478. The framing for the channel framed message is specified in FIG. 4. The channel framed message serves as an indicator to the peer relay server that the originator can communicate using the enhanced relay server protocol.

When a relay server 124, 124a receives a channel framed message on the TURN control port it checks to see if it has an allocated port that matches the destination port in the channel framed message. If the destination port is valid the relay server will check to see if permissions have been set to receive from the peer. If permission has been set and the channel framed message contains data the relay server 124, 124a will pass the data to the client in a DATA INDICATION message.

If a client uses the SERVICE QUALITY attribute to identify that it requires reliable delivery of data over a TCP session the relay servers 124, 124a will use a TCP session to carry the enhanced relay server protocol data. The operations are the same as for the UDP and non-reliable TCP except that instead of sending the channel framed data over UDP between the two TURN control ports for the relay servers 124, 124a, a TCP session is established from the allocated port of the sending relay server 124 to the TCP TURN control port 443 on the peer relay server 124a. Support for this scenario requires the administrator of the perimeter network 120 to open a range of ports on the external firewall for outbound TCP connections.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints.

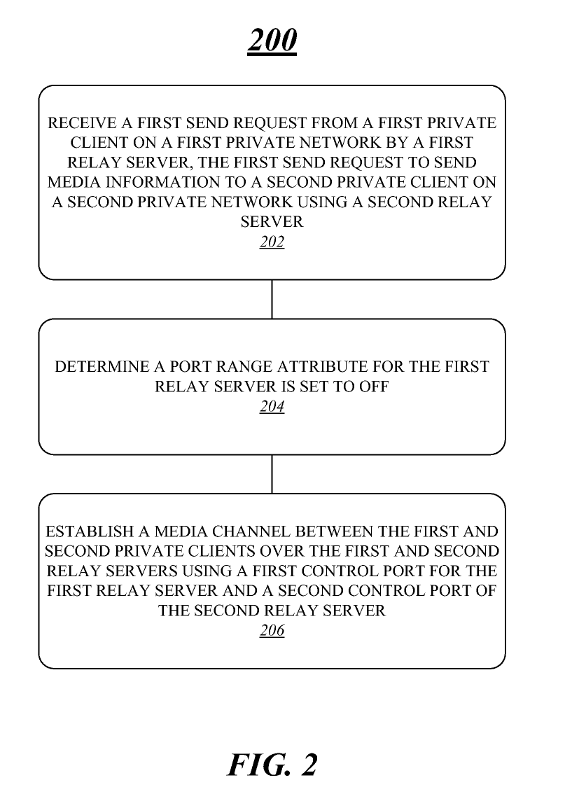

FIG. 2 illustrates a logic flow 200. The logic flow 200 may be representative of the operations executed by one or more embodiments described herein. The embodiments, however, are not limited to this representative logic flow 200.

In the illustrated embodiment shown in FIG. 2, the logic flow 200 may receive a first send request from a first private client on a first private network by a first relay server, the first send request to send media information to a second private client on a second private network using a second relay server at block 202. For example, the enhanced relay control module 160 of the relay server 124 may receive a first send request from a peer client 132-1 on the private network 130. The first send request may comprise a request to send media information to the peer client 132-1a on the private network 130a using the relay server 124a. An example of send request may include a SEND REQUEST as defined by the TURN suite of protocols.

The logic flow 200 may determine a port range attribute for the first relay server is set to off at block 204. For example, the enhanced relay control module 160 of the relay server 124 may determine a port range attribute for the relay server 124 is set to an OFF state. When the port range attribute is set to an OFF state, the relay server 124 has a certain range of ports for the public network interface closed and incapable of receiving incoming traffic from the public network 110. By way of contrast, when the port range attribute is set to an ON state, the relay server 124 has a certain range of ports for the public network interface opened and capable of receiving incoming traffic from the public network 110. In one embodiment, when the port range attribute is set to an ON state, then the enhanced relay control module 160 may establish media channels between the relay servers 124, 124a utilizing conventional STUN and/or TURN protocol operations.

The logic flow 200 may establish a media channel between the first and second private clients over the first and second relay servers using a first control port for the first relay server and a second control port of the second relay server at block 206. For example, the enhanced relay control module 160 of the relay server 124 may establish a media channel between the peer clients 132-1, 132-1a over the relay servers 124, 124a using a first control port for the relay server 124 and a second control port of the relay server 124a. In other words, the control ports for the relay servers 124, 124a may be used as substitute ports for the ports allocated to the peer clients 132-1, 132-1a to establish a media channel capable of traversing the public firewalls even when the allocated ports are in an OFF state.

Some implementations assume that the relay servers 124, 124a have an Internet Protocol Version Four (IPv4) address with either UDP or TCP connectivity, although others may be used. If the relay servers 124, 124a are behind a firewall it is assumed that the firewall has the TURN control ports opened for each network interface that the relay servers 124, 124a are running over. The relay servers 124, 124a are assumed to be ready to receive UDP datagrams on the TURN UDP control port or incoming TCP connections on the TURN TCP control port. If the TURN servers 124, 124a support application sharing or data transfer between federated clients, or any other application that needs a reliable TCP connection, it is assumed that the external firewall is configured to allow outbound TCP session establishment from a range of ports.

The enhanced relay server protocol can utilize various network transports based on various channel requirements. A particular network transport used for the enhanced relay server protocol depends on the network transport used by the client to connect to its local relay and the client's requirements for reliable delivery of data over a given media channel. For example, when the client is using UDP as a network transport for communicating with the relay server, then the media channel will be established using UDP. In another example, when the client is using TCP as a network transport and it does not require reliable delivery of the data, such as for RTP voice or video, the media channel will be established over UDP. In yet another example, when the client is using TCP as a transport and it does require reliable delivery of data, such as for application sharing or file transfer, the media channel will be established using TCP. The client uses the SERVICE QUALITY attribute in an authenticated ALLOCATE REQUEST message to identify TURN sessions that require reliable delivery of data.

A more detailed description of the enhanced relay server protocol is given below. This section describes a conceptual model of possible data organization that an implementation maintains to participate in the enhanced relay server protocol. The described organization is provided to facilitate the explanation of how the protocol behaves. The enhanced relay server protocol does not mandate that implementations adhere to this model as long as their external behavior is consistent with that described in the enhanced relay server protocol. For purposes of this description, the term “session” is used to identify a 5-tuple between a client and a server or between two servers. All TURN messages, raw data messages and channel framed messages arriving at a server are associated with a session. As used herein, the term “media channel” or simply “channel” is used to identify a flow of data between two TURN servers. A channel is specified by the 3-tuple identified by the Channel Number, the Source Port and the Destination Port within the channel framed message.

During initialization of the relay servers 124, 124a, the enhanced relay server protocol assumes that each relay server 124, 124a is able to receive UDP datagrams on UDP port 3478. Further, each relay server 124, 124a is assumed able to accept incoming TCP connections on TCP port 443. Although these two TURN control ports are used by way of example and not limitation, it may be appreciated that any uniquely designated port numbers can be used for a given implementation in an arbitrary manner. The embodiments are not limited in this context.

The enhanced relay server protocol allows for channel framed messages to be received on the TURN port. Previously the only messages allowed on the TURN port were either TURN framed messages or raw data messages which were valid only after a TURN session between a client and TURN server had transitioned to an active state through the use of the SET ACTIVE DESTINATION message. With the enhanced relay server protocol, a receiver on the TURN port needs to check for TURN messages and channel framed messages as well.

With the addition of channel framed messages, the enhanced relay server protocol implements logic to process the channel framed messages within the overall framework of the STUN and/or TURN protocols. The various message processing rules for channel framed messages, TURN messages, and non-TURN messages as implemented by the enhanced relay control modules 160, 160a may be described in the following sections.

As an initial matter, all messages received on the TURN control port should be verified as specified by the TURN protocol. Similarly, all TURN messages other than a SEND REQUEST message should be processed as specified by the TURN protocol.

When the TURN message is a SEND REQUEST message, the enhanced relay control modules 160, 160a performs message processing operations in accordance with the TURN protocol with some variations. Upon reception of a SEND REQUEST message, the enhanced relay control modules 160, 160a performs message processing as specified in the TURN protocol. In addition, the enhanced relay control modules 160, 160a for the respective relay servers 124, 124a perform some or all of the following message processing operations to establish a channel session with a peer relay server 124, 124a over which channel data can flow. For example, the relay servers 124, 124a form a channel framed message as described with reference to FIG. 4. If the network transport of the allocated port is UDP, the relay server 124 uses a unique identifier such as 0xFF00 for the Channel Number. If the network transport of the allocated port is TCP the server uses a unique identifier such as 0xFF01 for the Channel Number. The Length may be set to a standard value such as four (4) plus the length of any data that will be included in the channel framed message. The Source Port may be set to the local allocated address port. The Destination Port may be set to the port identified in the DESTINATION ADDRESS attribute of the SEND REQUEST message. The relay server 124 may optionally include the data payload identified by the DATA attribute of the SEND REQUEST message.

Continuing with the SEND REQUEST message processing operations, if the network transport of the allocated port is UDP or if the network transport of the allocated port is TCP and the client specified non-reliable data delivery in the SERVICE QUALITY attribute, then the relay servers 124, 124a may use UDP to send the channel framed message. The UDP datagram carrying the channel framed message may have a source address that is the same as the allocated transport address. The relay servers 124, 124a may use the TURN control port 3487 as the source port of the UDP datagram. The UDP datagram carrying the channel framed message may have a destination address that is the same as the address identified in the DESTINATION ADDRESS attribute. The destination port of the UDP datagram may be the TURN control port 3478.

Continuing with the SEND REQUEST message processing operations, if the network transport of the allocated port is TCP and the client specified reliable data delivery in the SERVICE QUALITY attribute, then the relay servers 124, 124a may use TCP to send the channel framed message. If a TCP connection has not been established between the relay servers 124, 124a and the transport address specified in the DESTINATION ADDRESS attribute of the SEND REQUEST message, the relay servers 124, 124a create a TCP connection. The TCP connection includes a source address that is the same as the allocated transport address. The relay servers 124, 124a may use the allocated port as the source port of the TCP connection. The TCP connection includes a destination address that is the same as the address identified in the DESTINATION ADDRESS attribute. The destination port of the TCP connection may be the TURN control port 443. Once the TCP connection is established the relay servers 124, 124a send the channel framed message over the media connection.

Referring again to the general message processing operations performed by the enhanced relay control modules 160, 160a, when a received message is not a TURN message the enhanced relay control modules 160, 160a determine whether the received message is part of a TURN session with a client. If the session is a TURN session and it has transitioned to an active state by the client sending a SET ACTIVE DESTINATION REQUEST message to the relay servers 124, 124a, the enhanced relay control modules 160, 160a may process the message using the same or similar message processing rules previously described for a SEND REQUEST message.

If the session is not a TURN session the message is verified as an inbound channel framed message. For example, if a message has been determined not to be a TURN framed message it is checked to see if it is a channel framed message. The enhanced relay control modules 160, 160a verifies whether the received message is a channel framed message and that it is properly formed. If the received message is not a valid channel framed message or properly formed it is silently dropped by the relay servers 124, 124a. The relay servers 124, 124a verify that the Length field in the channel framed message is greater than or equal to 4. If the length is less than 4 the packet is silently dropped by the relay servers 124, 124a. The relay servers 124, 124a also verify that the Destination Port in the channel framed message is a valid port in the TURN allocation range for the relay servers 124, 124a. If the port is not in the proper allocation range then the packet is silently dropped by the relay servers 124, 124a.

Upon receiving a valid channel framed data message, as either a UDP datagram or as data received over a TCP connection, the enhanced relay control modules 160, 160a checks the receive permissions set on the Destination Port against the transport address from which the channel framed message was received. If the client has not set permissions the packet is silently dropped by the relay servers 124, 124a. The enhanced relay control modules 160, 160a continue to process the data in the channel framed message as if it had been received directly at the allocated port in accordance with the TURN protocol.

If no firewall is blocking direct connectivity between the two relay servers 124, 124a, it is possible to establish connectivity over both a channel framed session and directly between the allocated ports. In this case direct connectivity to the allocated port may be desirable, and has the ability to switch from a channel framed communication mechanism to receiving directly on the allocated port. If the channel framed session is established first it will be used until data is received directly at the allocated port. Once data is received on the allocated port, connectivity is switched from the channel framed session to the direct connection on the allocated port.

The relay servers 124, 124a may also have special message processing operations for ALLOCATE REQUEST messages. Upon reception of an ALLOCATION REQUEST message, the relay servers 124, 124a perform message processing as specified by the TURN protocol. In addition, the relay servers 124, 124a performs some special processing. For example, if the request contains a SERVICE QUALITY attribute the relay servers 124, 124a verify that it supports the requested Service Type and Stream Type. If the Service Type is not supported, the relay servers 124, 124a respond with an ALLOCATE ERROR RESPONSE message with an error response code of 415 representing an Unsupported Media Type. An example of an unsupported Service Type would be a request for reliable delivery by a UDP allocation. If the Stream Type is not supported the relay servers 124, 124a respond with an ALLOCATE ERROR RESPONSE message containing an error response code of 415 representing the Unsupported Media Type. If the request does not contain a SERVICE QUALITY attribute, the relay servers 124, 124a default to a Service Type of best-effort delivery.

In some cases, the relay servers 124, 124a may receive non-TURN data from a client. Upon receiving non-TURN framed data from the client the relay servers 124, 124a performs message processing as specified by the TURN protocol. If it is determined that the active destination set for the client is using a channel session for transporting data, the relay servers 124, 124a forms a channel framed message. If the network transport of the allocated port is UDP the relay servers 124, 124a use 0xFF00 for the Channel Number. If the network transport of the allocated port is TCP the relay servers 124, 124a use 0xFF01 for the Channel Number. The Length is set to 4 plus the length of the non-TURN framed data that will be included in the message. The Source Port is set to the local allocated address port. The Destination Port is set to the port identified in the DESTINATION ADDRESS attribute of the SEND REQUEST message. The relay servers 124, 124a include the non-TURN framed data from the client. If the network transport of the allocated port is UDP or if the network transport of the allocated port is TCP and the client specified non-reliable data delivery in the SERVICE QUALITY attribute, the relay servers 124, 124a use UDP to send the channel framed data message. The UDP datagram carrying the channel framed message may have a source address that is the same as the allocated transport address. The relay servers 124, 124a should use the TURN port 3487 as the source port of the UDP datagram. The UDP datagram carrying the channel framed data message has a destination address that is the same as the address identified in the DESTINATION ADDRESS attribute. The destination port of the UDP datagram is set to the TURN port 3478. If the network transport of the allocated port is TCP and the client specified reliable data delivery in the SERVICE QUALITY attribute, the relay servers 124, 124a use TCP to send the channel framed message. If a TCP connection has not been established between the relay server 124, 124a and the transport address specified in the DESTINATION ADDRESS attribute of the SET ACTIVE DESTINATION REQUEST, the relay servers 124, 124a create a TCP connection. The TCP connection may have a source address that is the same as the allocated transport address. The relay server 124, 124a should use the allocated port as the source port of the TCP connection. The TCP connection has a destination address that is the same as the address identified in the DESTINATION ADDRESS attribute. The destination port of the TCP connection is the TURN port 443. Once the TCP connection is established the relay server 124, 124a sends the channel framed data message over the connection.

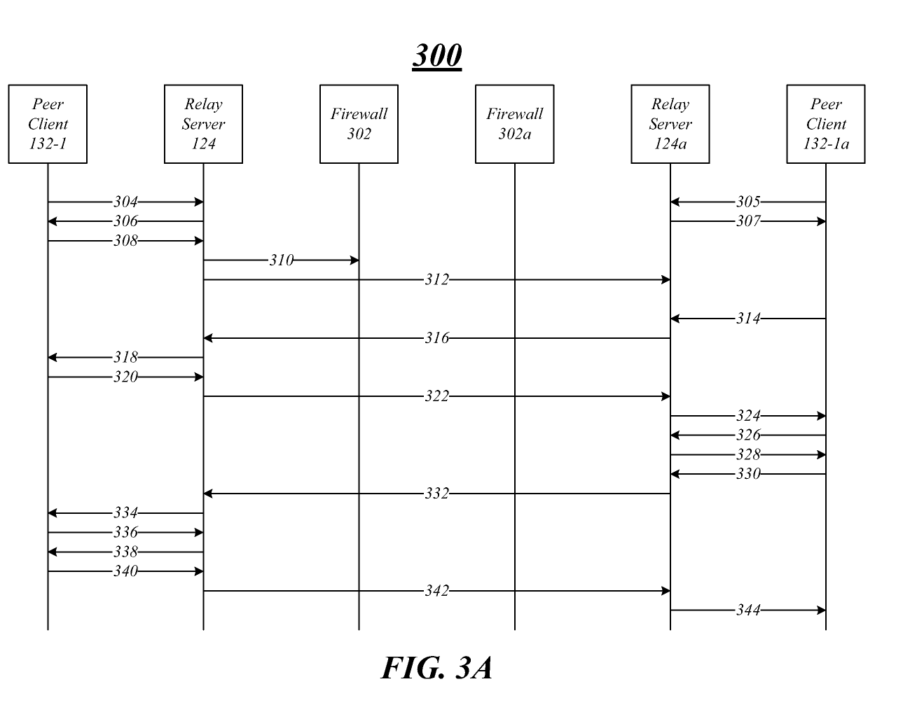

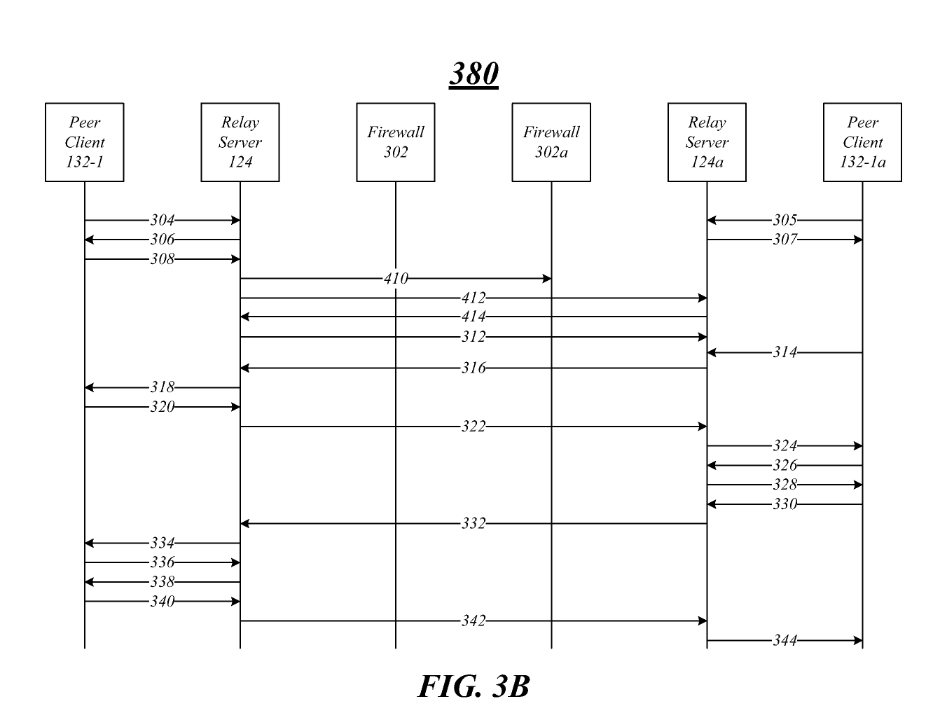

FIG. 3A illustrates a message flow 300. The message flow 300 may be representative of a message flow between various elements of the communications system 100 as described with reference to FIG. 1. More particularly, the message flow 300 may provide a more detailed example of the message flow and operations of the communications system 100.

For the message flow 300, the peer client 132-1 is assumed to be an authenticated user from a first business entity. The peer client 132-1 is behind the NAT 128 and is using the relay server 124 in the perimeter network 120 to allocate a publicly accessible transport address. Similarly, the peer client 132-1a is assumed to be an authenticated user from a second business entity. The peer client 132-1a is behind the NAT 128a and is using the relay server 124a in the perimeter network 120a to allocate a publicly accessible transport address. The external firewalls 302, 302a for both business entities have UDP port 3478 and TCP port 443 open for bi-directional communication. In addition both external firewalls have port range 50,000-60,000 open for outbound TCP sessions.

In the illustrated embodiment shown in FIG. 3A, assume the two peer clients 132-1, 132-1a desire to establish a media flow between them using UDP as the network transport. They exchange the public transport addresses they allocated from their respective relay servers 124, 124a in the SDP of the SIP dialog sent from the peer clients 132-1, 132-1a using conventional SDP and SIP techniques. For example, the peer client 132-1 uses the TURN protocol to allocate a UDP public transport address from the relay server 124. The peer client 132-1 sends an ALLOCATE REQUEST message to the relay server 124 as indicated by the arrow 304. The relay server 124 sends an ALLOCATE RESPONSE message with port allocations for the peer client 132-1 as indicated by the arrow 306. The peer client 132-1a performs similar port allocation operations to allocate a UDP public transport address from the relay server 124a as indicated by the arrows 305, 307.

Once ports have been allocated, the peer client 132-1 sends data to the public transport address of the peer client 132-1a using a SEND REQUEST message as indicated by the arrow 308. The SEND REQUEST contains a DESTINATION ADDRESS attribute with the destination address comprising the public transport address of the peer client 132-1a as allocated by the relay server 124a. The relay server 124 checks the connection cache associated with the allocated port for the peer client 132-1 and finds no connection information, so it attempts to send the raw data from the allocated transport address of the peer client 132-1 to the allocated transport address for the peer client 132-1a on the relay server 124a.

Since the external edge firewall 302 is configured such that the allocated port range of the relay server 124 is closed, the outbound data is dropped at the firewall 302 as indicated by the arrow 310. In parallel, the relay server 124 sends a UDP datagram containing a channel framed message as indicated by the arrow 312. The channel framed message contains a Channel Number of 0xFF00, a Length of 4, a Source Port of the public transport address for the peer client 132-1, a Destination Port of the public transport address of the peer client 132-1a, and a 0 byte data payload. The source address of the UDP datagram is the public transport address of the relay server 124 and the source port is the TURN port 3478. The destination address of the UDP datagram is the address specified in the DESTINATION ADDRESS attribute of the SEND REQUEST message, which is the public transport address of the relay server 124a, and the destination port is the TURN port 3478.

The relay server 124a receives the channel framed data message and verifies that the destination port in the message is a port that it owns. It checks the port for permissions to verify that the peer client 132-1a will allow data to be received from the allocated address of the peer client 132-1. Since the peer client 132-1a has not yet set permissions the channel framed data message is dropped. The relay server 124a caches connection information that channel data was received at the public transport address of the peer client 132-1a from the public transport address of the peer client 132-1.

The peer client 132-1a sends data to public transport address for the peer client 132-1 using a SEND REQUEST message as indicated by the arrow 314. The SEND REQUEST contains a DESTINATION ADDRESS attribute with the destination address set to the public transport address of the peer client 132-1 as allocated by the relay server 124.

The relay server 124a checks the connection cache associated with the allocated port for the peer client 132-1a and finds that it has a channel session with the relay server 124 for the transport of data between the allocated port on the relay server 124a and the allocated port on the relay server 124. The relay server 124a sends a UDP datagram containing a channel framed message as indicated by the arrow 316. The channel framed message contains a Channel Number of 0xFF00, a Length of 4 plus a length of data in the DATA attribute, a Source Port of the public transport address for the peer client 132-1a, a Destination Port of the public transport address for the peer client 132-1, followed by the data payload specified in the DATA attribute of the SEND REQUEST message. The source address of the UDP datagram is the public transport address of the relay server 124a and the source port is the TURN port 3478. The destination address of the UDP datagram is the public transport address of the relay server 124 and the destination port is the TURN port 3487.

The relay server 124 receives the channel framed data message and verifies that the destination port in the message is a port that it owns. It checks the port for permissions to verify that the peer client 132-1 will allow data to be received from the allocated address for the peer client 132-1a. Since the peer client 132-1 has done a previous SEND REQUEST to the peer client 132-1a permissions are set and the relay server 124 takes the data from the channel framed data message and sends it to the peer client 132-1 in a DATA INDICATION message as indicated by the arrow 318.

The peer client 132-1 sends data to the public transport address for the peer client 132-1a using a SEND REQUEST message as indicated by the arrow 320. The SEND REQUEST message contains a DESTINATION ADDRESS attribute with the destination address of the public transport address for the peer client 132-1a as allocated by the relay server 124a.

The relay server 124 checks the connection cache associated with the allocated port for the peer client 132-1 and finds a channel session with the relay server 124a for the transport of data between the allocated port on the relay server 124 and the allocated port on the relay server 124a. The relay server 124 sends a UDP datagram containing a channel framed message as indicated by the arrow 322. The channel framed message contains a Channel Number of 0xFF00, a Length of 4 plus the length of data in the DATA attribute, a Source Port of the public transport address of the peer client 132-1, a Destination Port of the public transport address for the peer client 132-1a, followed by the data payload specified in the DATA attribute of the SEND REQUEST message. The source address of the UDP datagram is the public transport address of the relay server 124 and the source port is the TURN port 3478. The destination address of the UDP datagram is the public transport address of the relay server 124a and the destination port is the TURN port 3487.

The relay server 124a receives the channel framed data message and verifies that the destination port in the message is a port that it owns. It checks the port for permissions to verify that the peer client 132-1a will allow data to be received from the allocated address for the peer client 132-1. Since the peer client 132-1a has done a previous SEND REQUEST to the peer client 132-1, permissions are set and the relay server 124a takes the data from the channel framed data message and sends it to the peer client 132-1a in a DATA INDICATION message as indicated by the arrow 324.

The peer client 132-1a is now ready to make the peer client 132-1 the active peer to streamline data transfer. A SET ACTIVE DESTINATION REQUEST message is sent to the relay server 124a with a DESTINATION ADDRESS attribute that contains the public transport address for the peer client 132-1 as indicated by the arrow 326. When the relay server 124a receives the request it identifies the channel session with the relay server 124 as the active destination and sends a SET ACTIVE DESTINATION RESPONSE message back to the peer client 132-1a as indicated by the arrow 328.

The peer client 132-1a can now send non-TURN framed data to the relay server 124a as indicated by the arrow 330. When the relay server 124a receives the non-TURN framed data from the peer client 132-1a, it looks up the active destination and finds the channel session with the relay server 124. The relay server 124a sends a UDP datagram containing a channel framed message as indicated by the arrow 332. The channel framed message contains a Channel Number of 0xFF00, a Length of 4 plus length of the non-TURN framed data, a Source Port of the public transport address for the peer client 132-1a, a Destination Port of the public transport address for the peer client 132-1, followed by the non-TURN framed data received from the peer client 132-1a. The source address of the UDP datagram is the public transport address of the relay server 124a and the source port is the TURN port 3478. The destination address of the UDP datagram is the public transport address of the relay server 124 and the destination port is the TURN port 3487.

The relay server 124 receives the channel framed data message and verifies that the destination port in the message is a port that it owns. It checks the port for permissions to verify that the peer client 132-1 will allow data to be received from the allocated address for the peer client 132-1a. Since the peer client 132-1 has done a previous SEND REQUEST to the peer client 132-1a permissions are set and the relay server 124 takes the data from the channel framed data message and sends it to the peer client 132-1 in a DATA INDICATION message as indicated by the arrow 334.

The peer client 132-1 is now ready to make the peer client 132-1a the active peer to streamline data transfer. A SET ACTIVE DESTINATION REQUEST message is sent to the relay server 124 with a DESTINATION ADDRESS attribute that contains the public transport address for the peer client 132-1a as indicated by the arrow 336. When the relay server 124 receives the request it identifies the channel session with the relay server 124a as the active destination and sends a SET ACTIVE DESTINATION RESPONSE message back to the peer client 132-1 as indicated by the arrow 338.

The peer client 132-1 can now send non-TURN framed data to the relay server 124 as indicated by the arrow 340. When the relay server 124 receives the non-TURN framed data from the peer client 132-1 it looks up the active destination and finds the channel session with the relay server 124a. The relay server 124 sends a UDP datagram containing a channel framed message as indicated by the arrow 342. The channel framed message contains a Channel Number of 0xFF00, a Length of 4 plus a length of the non-TURN framed data, a Source Port of the public transport address for the peer client 132-1, a Destination Port of the public transport address for the peer client 132-1a, followed by the non-TURN framed data received from the peer client 132-1. The source address of the UDP datagram is the public transport address of the relay server 124 and the source port is the TURN port 3478. The destination address of the UDP datagram is the public transport address of the relay server 124a and the destination port is the TURN port 3478.

The relay server 124a receives the channel framed data message and verifies that the destination port in the message is a port that it owns. It checks the port for permissions to verify that the peer client 132-1a will allow data to be received from the allocated address for the peer client 132-1. Since the peer client 132-1a has done a previous SEND REQUEST to the peer client 132-1, permissions are set and the relay server 124a takes the data from the channel framed data message and sends it to the peer client 132-1a in a DATA INDICATION message as indicated by the arrow 344. The relay servers 124, 124a may use the established media channel to send media information on behalf of the peer clients 132-1, 132-1a.

FIG. 3B illustrates a message flow 380. The message flow 380 may be representative of a message flow between various elements of the communications system 100 as described with reference to FIG. 1. More particularly, the message flow 380 may provide a more detailed example of the message flow and operations of the communications system 100.

The message flow 380 illustrates an exemplary message flow similar the message flow 300, with the exception that the message flow 380 assumes the two peer clients 132-1, 132-1a desire to establish a media flow between them using TCP as the network transport. As such, the message flow 380 includes the arrows 410, 412 and 414 to indicate TCP messaging operations. For example, the relay server 124 may receive a SEND REQUEST message from the peer client 132-1, and checks the connection cache associated with the allocated port for the peer client 132-1 and finds no connection information. It therefore attempts to create a TCP connection using a TCP SYN message to the allocated public transport address for the peer client 132-1a on the relay server 124a as indicated by the arrow 410. Since the external edge firewall 302a for the relay server 124a is configured to block incoming TCP connections to the relay server 124a for all ports except TCP control port 443, this connection attempt will fail at the firewall 302a. In parallel the relay server 124 attempts to create a TCP connection to the IP address specified in the DESTINATION ADDRESS attribute of the SEND REQUEST message but uses the TCP control port 443 as the destination port. The relay server 124 sends a TCP SYN message to the relay server 124a as indicated by the arrow 412. Since the firewall 302a is open to incoming TCP connections on the TCP control port 443 this connection succeeds, and the relay server 124a sends a TCP SYN-ACK to the relay server 124 as indicated by the arrow 414. Once the connection has completed the relay server 124 sends a channel framed message over the TCP connection. Message flow operations continue as described with reference to the message flow 300.

FIG. 4 illustrates one embodiment of a channel framed message 400. Channels are established between the relay servers 124, 124a through the use of special channel framed messages. In one embodiment, the channel framed messages comprise an 8 byte header followed by 0 or more bytes of data. The channel framed message 400 provides an exemplary header suitable for use with the enhanced relay server protocol. It may be appreciated that other data structures may be used for the channel framed message as desired for a given implementation. The embodiments are not limited in this context.

In the illustrated embodiment shown in FIG. 4, the channel framed message 400 comprises an 8 byte header having a Channel Number field 402, a Length field 404, a Source Port field 406, a Destination Port field 408, and a variable length Data field 410. The Channel Number field 402 may comprise 16 bits and identifies a channel used to carry data between the relay servers 124, 124a. The Length field 404 is 16 bits and counts the number of bytes of the frame following immediately after the Length field itself. The Source Port field 406 is 16 bits and identifies the allocated port on the sending relay. The Destination Port field 408 is 16 bits and identifies the allocated port on the receiving relay.

More particularly, the Channel Number field 402 may comprise 16 bits and identifies a channel used to carry data between the relay servers 124, 124a. The channel number may be in the range from 0xFF00 to 0xFFFE inclusive. The channels identify the transport of the allocated port. The use of channels allows for a different transport to be used to carry the channel data between the relay servers 124, 124a then what is used for the individual client legs of the end-to-end session. Examples of supported channel numbers may be shown in Table 1 as follows:

TABLE 1

| Channel Number | Transport of Allocated ports |
|---|---|
| 0xFF00 | UDP |
| 0xFF01 | TCP |

The various embodiments may optionally implement a SERVICE QUALITY attribute for the enhanced relay server protocol. The SERVICE QUALITY attribute is used to specify the type of service required by the client for the allocated transport address. The SERVICE QUALITY attribute is supplied as part of an authenticated ALLOCATE REQUEST message which is specified in the TURN protocol. If the SERVICE QUALITY attribute is not present the relay server 124, 124a provides best effort delivery over the allocated transport address.

The SERVICE QUALITY attribute may have a header structure of similar size as the channel framed message 400 (e.g., 8 bytes) with fields for an attribute type, an attribute length, a service type and a stream type. Examples for the attribute type and an attribute length may comprise 0x8055 and 0x0004 respectively.

The service type field may be 16 bits and carriers the service type that is required over this allocated port. Examples of supported values are shown in Table 2 as follows:

TABLE 2

| Service | |
|---|---|
| Type | Description |
| 0x0000 | Best effort delivery of data over the allocated port |
| 0x0001 | Reliable delivery of data over the allocated port. Only valid if |
| | the client is using TCP as a transport. |
| | If the client is using UDP as a transport and requests reliable |
| | delivery the TURN server should respond with an Allocate Error |
| | Response message with an error response code of 415 |
| | (Unsupported Media Type). |

The stream field may be 16 bits and specifies the type of data stream being transported over the allocated port. Examples of supported values are shown in Table 3 as follows:

TABLE 3

| Stream Type | Description |
|---|---|
| 0x0000 | Reserved |
| 0x0001 | Audio stream, High Priority |
| 0x0002 | Main video stream |
| 0x0003 | Supplemental video stream (panoramic video) |
| 0x0004 | Data |

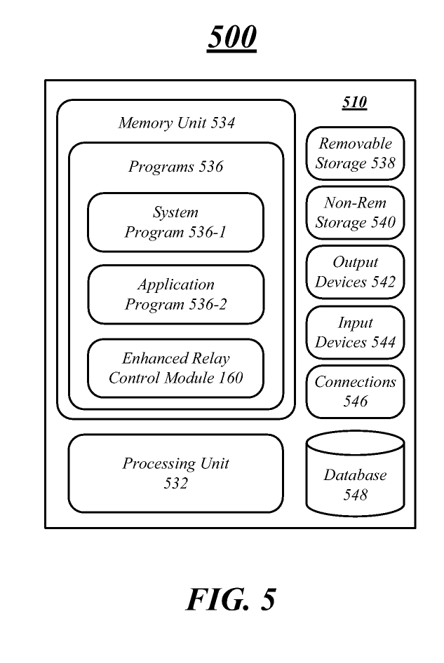

FIG. 5 further illustrates a more detailed block diagram of computing architecture 510 suitable for implementing various embodiments. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more software programs 536-1-t and accompanying data. Depending on the implementation, examples of software programs 536-1-t may include a system program 536-1 (e.g., an operating system), an application program 536-2 (e.g., a web browser), the enhanced relay control module 160, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may be representative of, for example, the communications interfaces for the communications components 116-1-v. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

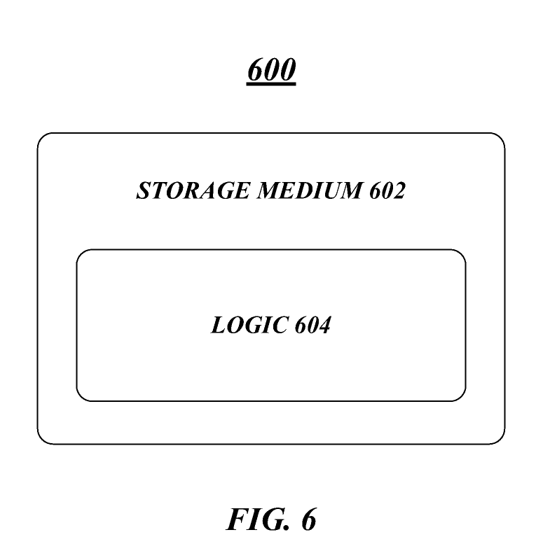

FIG. 6 illustrates a diagram an article of manufacture 600 suitable for storing logic for the various embodiments. As shown, the article of manufacture 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article of manufacture 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a first send request from a first private client on a first private network by a first relay server, the first send request to send media information to a second private client on a second private network using a second relay server;
determining a port range attribute for the first relay server is set to off; and
establishing a media channel between the first and second private clients over the first and second relay servers using a first control port for the first relay server and a second control port of the second relay server.

2. The method of claim 1, comprising allocating a first public transport address and a first source port to the first private client by the first relay server.

3. The method of claim 2, comprising receiving a send request from the first private client having a destination address attribute with a second public transport address and a second source port for the second private client by the first relay server.

4. The method of claim 3, comprising setting permissions for a channel session between the first and second relay servers.

5. The method of claim 4, comprising sending a first datagram having a source address as the first public transport address and the first control port for the first relay server, and a destination address as the second public transport address and a second control port for the second relay server.

6. The method of claim 5, comprising sending the first datagram with a first channel framed message having a channel number, a length, a source port as the first source port, and a destination port as the second source port.

7. The method of claim 6, comprising receiving a second datagram having a source address as the second public transport address and the second control port for the second relay server, and a destination address as the first public transport address and the first control port for the first relay server.

8. The method of claim 7, comprising receiving the second datagram with a second channel framed message having the channel number, a length, a source port as the second source port, a destination port as the first source port, and a data payload as media information.

9. The method of claim 8, comprising determining whether the second channel framed message has permission for the channel session between the first and second relay servers.

10. The method of claim 9, comprising sending a data indication message having the media information from the data payload of the second channel framed message to the first private client.

11. The method of claim 10, comprising receiving a set active destination request to set the channel session with the second private client as the active destination for the media channel.

12. An article comprising a storage medium containing instructions that if executed enable a system to:
receive a first send request from a first private client on a first private network for a second private client on a second private network by a first relay server;
determine a port range attribute for the first relay server is set to off; and
establish a media channel between the first and second private clients to communicate media information over a network transport using a first control port for the first relay server.

13. The article of claim 12, comprising instructions that if executed enable the system to:
allocate a first public transport address and a first source port to the first private client by the first relay server;
receive a send request from the first private client having a destination address attribute with a second public transport address and a second source port for the second private client by the first relay server;
set permissions for a channel session between the first relay server and a second relay server for the second private client; and
send a first datagram having a source address as the first public transport address and the first control port for the first relay server, and a destination address as the second public transport address and a second control port for the second relay server, the first datagram with a first channel framed message having a channel number, a length, a source port as the first source port, and a destination port as the second source port.

14. The article of claim 13, comprising instructions that if executed enable the system to:
receive a second datagram having a source address as the second public transport address and the second control port for the second relay server, and a destination address as the first public transport address and the first control port for the first relay server, the second datagram having a second channel framed message with the channel number, a length, a source port as the second source port, a destination port as the first source port, and a data payload as media information;
determine whether the second channel framed message has permission for the channel session between the first and second relay servers; and
send a data indication message having the media information from the data payload of the second channel framed message to the first private client.

15. The article of claim 14, comprising instructions that if executed enable the system to allocate a first public transport address and a first source port to the first private client by the first relay server in response to an allocate request message, the allocate request message having a service quality attribute indicating the first private client needs a reliable network transport.

16. A system, comprising:
a first relay server having an enhanced relay control module operative to manage communications between private clients communicating over the first relay server and a second relay server, the enhanced relay control module to establish a media channel between control ports for the first and second relay servers when a port range attribute for at least one of the first or second relay servers is turned off.

17. The system of claim 16, comprising the enhanced relay control module operative to use a network transport comprising a user datagram protocol or a transmission control protocol to communicate media information over the media channel.

18. The system of claim 16, comprising a first private client communicatively coupled to a first network address translator, the first network address translator communicatively coupled to the first relay server, the enhanced relay control module operative to establish the media channel with the first private client as a first endpoint and the media channel to traverse the first network address translator and the first relay server.

19. The system of claim 16, comprising a second private client communicatively coupled to a second network address translator, the second network address translator communicatively coupled to the second relay server, the enhanced relay control module operative to establish the media channel with the second private client as a second endpoint and the media channel to traverse the second network address translator and the second relay server.

20. The system of claim 16, the enhanced relay control module operative to establish the media channel between control ports for the first and second relay servers over a public network using an enhanced relay server protocol.
